(19) United States
(12) Patent Application Publication
(10) Pub. No.: US 2017/0095397 A1
(43) Pub. Date: Apr. 6, 2017

(54) WAND ASSEMBLY AND ASSOCIATED WAND SYSTEM

(71) Applicant: Lotions Limited, LLC, Madison, WI (US)

(72) Inventors: Ellen L. Barnard, Madison, WI (US); Myrtle Wilhite, Madison, WI (US)

(21) Appl. No.: 15/282,595

(22) Filed: Sep. 30, 2016

Related U.S. Application Data
(60) Provisional application No. 62/236,550, filed on Oct. 2, 2015.

(51) Int. Cl. A61H 19/00; A61H 23/02

(52) U.S. Cl. CPC A61H 19/34; A61H 19/44; A61H 23/02; A61H 2205/087

(57) ABSTRACT

A wand system includes a plurality of wand portions, each wand portion having at least one dimension that differs from the other wand portions, and a handle portion that defines an aperture through the handle portion. Each of the plurality of wand portions is configured to removably engage the handle portion to define a wand assembly.

### CROSS-REFERENCE TO RELATED APPLICATIONS

This application claims priority to U.S. Provisional Patent Application No. 62/236,550, filed on Oct. 2, 2015, and entitled “Wand Assembly and Associated Wand System,” the contents of which is hereby incorporated by reference in its entirety.

### FIELD

The present application relates to a wand assembly having a selectively removable and replaceable shaft. More specifically, the application relates to a wand system having a plurality of different sized shafts that removably engage a handle portion to facilitate the selective attachment of a shaft having a desired size.

### BACKGROUND

A wand is a device intended to be inserted into a female vagina, and is generally known in the art. Wands that are known include motorized wands and non-motorized wands. Motorized wands generally include a motor for generating a vibration, while non-motorized wands do not include such a motor. Wands may be constructed of a number of materials, such as plastic, thermoplastic, or rubber. Wands are generally sold as a single unit of a predetermined size (length and width/diameter). If a user desires a wand of a different size, the user must purchase another, separate wand having that desired different size.

### SUMMARY

In one independent aspect, a wand system or wand kit may generally include a plurality of wand portions, each wand portion having at least one dimension that differs from the other wand portions, and a handle portion defining an aperture through the handle portion. Each of the plurality of wand portions is configured to removably engage the handle portion to define a wand assembly.

Other independent features and independent aspects of the invention will become apparent by consideration of the following detailed description, claims and accompanying drawings.

### BRIEF DESCRIPTION OF THE DRAWINGS

FIG. 1 is an isometric view of a wand assembly that includes a wand portion removably attached to a handle portion.

FIG. 2 is a side elevation view of the wand assembly of FIG. 1.

FIG. 3 is an isometric view of the handle portion of the wand assembly of FIG. 1, with the wand portion removed.

FIG. 4 is a side elevation view of the handle portion of FIG. 3.

FIG. 5 is an elevation view of the handle portion of FIG. 3, taken along line 5-5 of FIG. 4.

FIG. 6 is a cross-sectional view of the handle portion of FIG. 4, taken along line 6-6 of FIG. 5.

FIG. 7 is an isometric view of the wand portion of the wand assembly of FIG. 1, with the handle portion removed.

FIG. 8 is an isometric view of the wand portion of FIG. 7, taken from the opposite side.

FIG. 9 is a side elevation view of the wand portion of FIG. 7.

FIG. 10 is a cross-sectional view of the wand portion of FIG. 9.

FIG. 11 is a partially exploded view of the wand portion of FIG. 7, illustrating an insert housing removed from a sheath.

FIG. 12 is a side elevation view of the wand assembly of FIG. 1.

FIG. 13 is an elevation view of a portion of the wand assembly of FIG. 1, with the wand portion cut off by broken lines, and illustrating a portion of the locking assembly and associated indicia to guide locking of the handle portion to the wand portion.

FIG. 14 is a side elevation view of a first wand portion for use with the handle portion of FIG. 3 to form the wand system of FIG. 1, the illustrated first wand portion having a first size.

FIG. 15 is a side elevation view of a second wand portion for use with the handle portion of FIG. 3 to form the wand system of FIG. 1, the illustrated second wand portion having a second size.

FIG. 16 is a side elevation view of a third wand portion for use with the handle portion of FIG. 3 to form the wand system of FIG. 1, the illustrated third wand portion having a third size.

FIG. 17 is a side elevation view of a fourth wand portion for use with the handle portion of FIG. 3 to form the wand system of FIG. 1, the illustrated fourth wand portion having a fourth size.

### DETAILED DESCRIPTION

Before any independent embodiments of the present invention are explained in detail, it should be understood that the invention is not limited in its application to the details or construction and the arrangement of components as set forth in the following description or as illustrated in the drawings. The invention is capable of other independent embodiments and of being practiced or of being carried out in various ways.

It should be understood that the description of specific embodiments is not intended to limit the disclosure from covering all modifications, equivalents and alternatives falling within the spirit and scope of the disclosure. Also, it is to be understood that the phraseology and terminology used herein is for the purpose of description and should not be regarded as limiting.

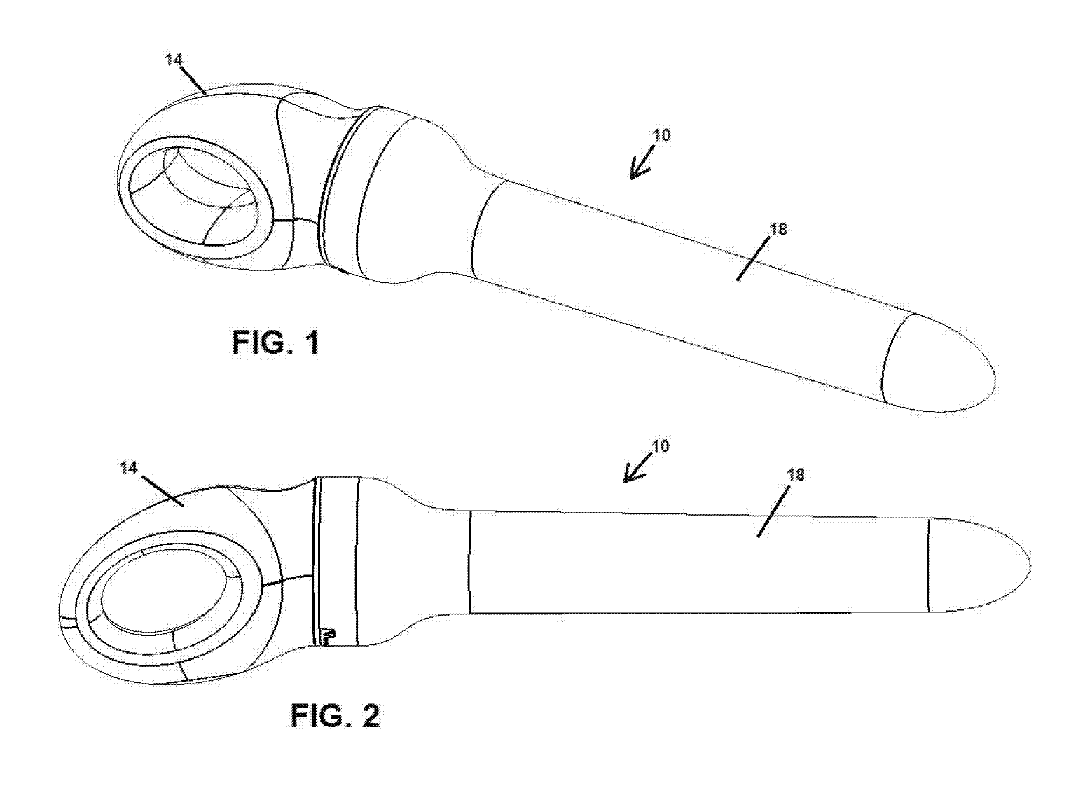

Referring now to the figures, one or more examples of embodiments of a wand assembly 10 are depicted. Referring specifically to FIGS. 1-2, the illustrated embodiment of the wand assembly 10 includes a handle or handle portion 14 that is coupled to a wand or wand portion 18. The wand 18 removably couples to the handle 14 to facilitate selective removal and replacement of the wand 18 with the handle 14.

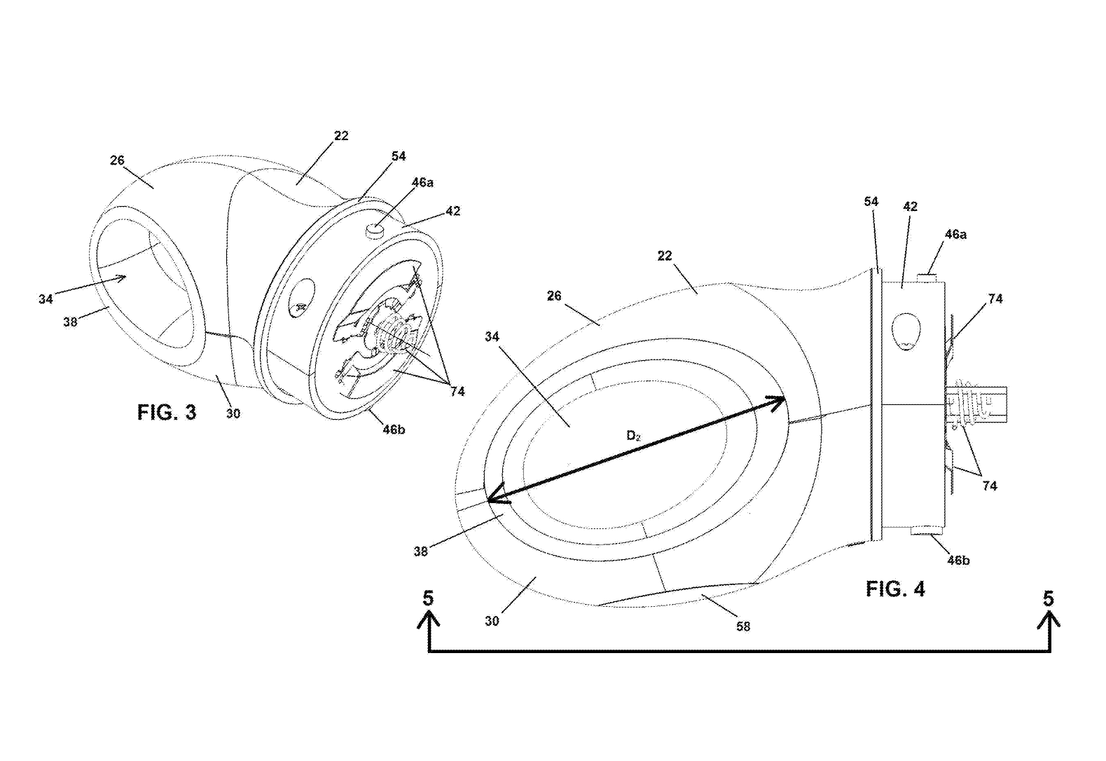

Referring now to FIGS. 3-6, the handle 14 is illustrated with the wand 18 removed. As illustrated in FIGS. 3-4, the handle 14 includes a housing 22. The housing 22 is shown as defined by a first housing portion 26 and a second housing portion 30. The first and second portions 26, 30 coupled together or interconnect to form the housing 22. While the illustrated embodiment has the housing 22 being defined by two housing portions 26, 30, in other embodiments the housing 22 can be formed of a single portion or a plurality of portions (e.g., two or more portions, etc.).

The housing 22 also includes an aperture or control aperture 34. A portion of the housing 22 defines and substantially surrounds the aperture 34. The aperture 34 extends entirely through the housing 22, and can be bordered by an insert or loop 38. The insert 38 is positioned in (or received by) the housing 22, and is formed of a material different than the housing 22. For example, in the illustrated embodiment, the housing 22 is formed of a first material (e.g., a hardened plastic, etc.), while the insert 38 is formed of a second material (e.g., a thermoplastic, etc.) that is different than the first material. Preferably, the second material forming the insert 38 is a material having a greater amount of elasticity (or less rigidity) that the first material. This improves the tactile perception of the handle 14, as a user may place one or more fingers or a portion of a hand through the aperture 34, with the portion of the housing 22 that substantially surrounds the aperture 34 acting as a handle to facilitate adjustment or manipulation of the wand 18.

As illustrated in FIGS. 4 and 6, the aperture 34 (and the associated insert 38) has a narrowing diameter from the housing 22 into the aperture 34 until approximately a midpoint or a middle of the aperture 34. From the middle, the aperture 34 has an expanding diameter through to the other side of the aperture 34. Stated another way, the middle or midpoint of the aperture 34 has a first diameter D₁ (shown in FIG. 6) that is less than a second diameter D₂ (shown in FIG. 4) of the aperture 34 at one or both ends of the aperture 34 (e.g., the diameter of the aperture 34 as it begins to pass through the housing 22).

Referring back to FIGS. 3-4, the aperture 34 is illustrated as having an oblong or oval cross-sectional shape. In other embodiments, the aperture 34 can have a round, circular, polygonal, or any other suitable cross-sectional shape.

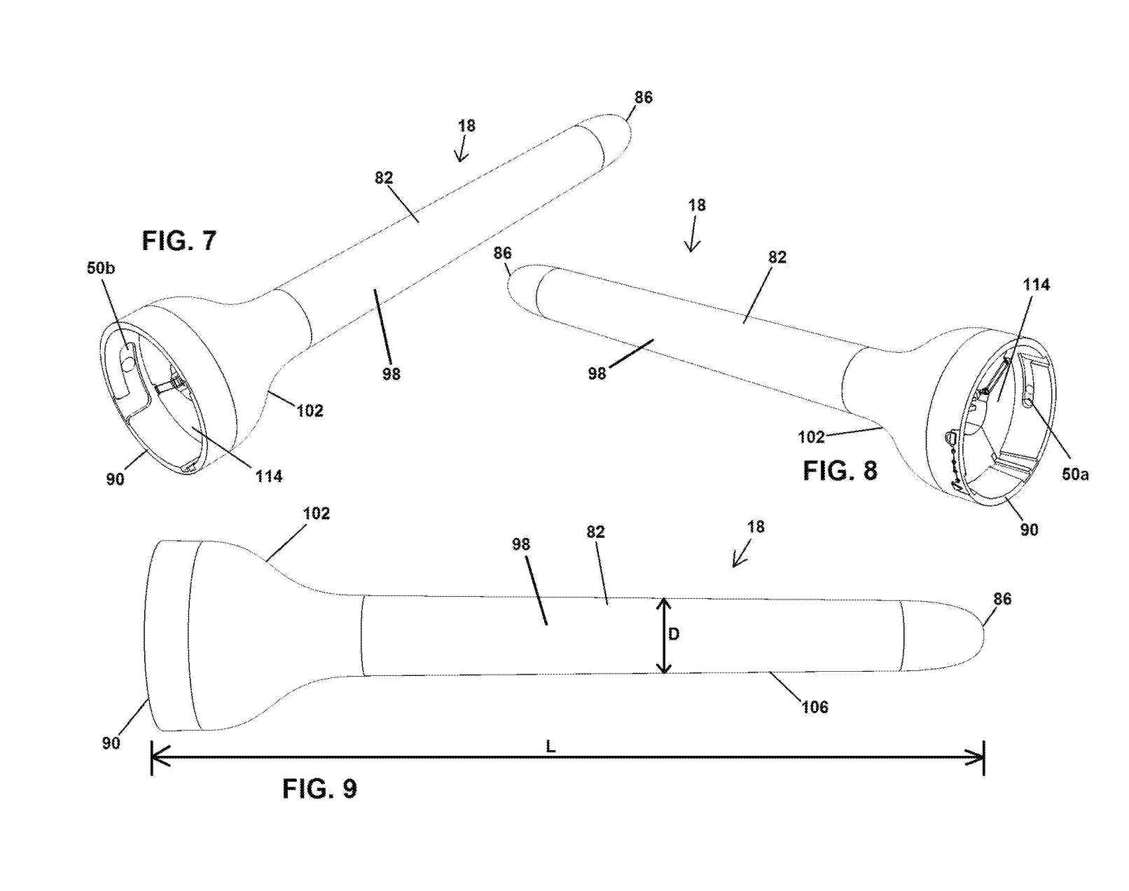

The housing 22 also includes a wand engaging portion 42. The wand engaging portion 42 is configured to engage and retain the wand 18. In the illustrated embodiment, the wand engaging portion 42 has a diameter (not shown) that is less than a cross-sectional width (not shown) of the housing 22. This allows the wand engaging portion 42 to be received by the wand 18, and allows the wand 18 to mate or be positioned flush to the housing 22 of the handle 14. Stated otherwise, an outer surface of the housing 22 extends gradually or continuously to the wand 18 without exposing any sharp or sudden portions of the housing 22 or wand 18 that could lead to injury during use of the wand assembly 10. The wand engaging portion 42 includes a plurality of projections 46a, 46b that are configured to engage respective slots 50a, 50b in the wand 18 (shown in FIGS. 7-8). In the illustrated embodiment, projection 46a has a different size (i.e. a smaller diameter) than projection 46b. This is to facilitate engagement with the proper respective slot 50a, 50b, which each have different sizes configured to receive the respective projection 46a, 46b (e.g., slot 50a receives projection 46a, and slot 50b receives projection 46b). The wand engaging portion 42 can also carry a controller seal or O-ring 54. The seal 54 provides a seal between the handle 14 and the wand 18 when connected together.

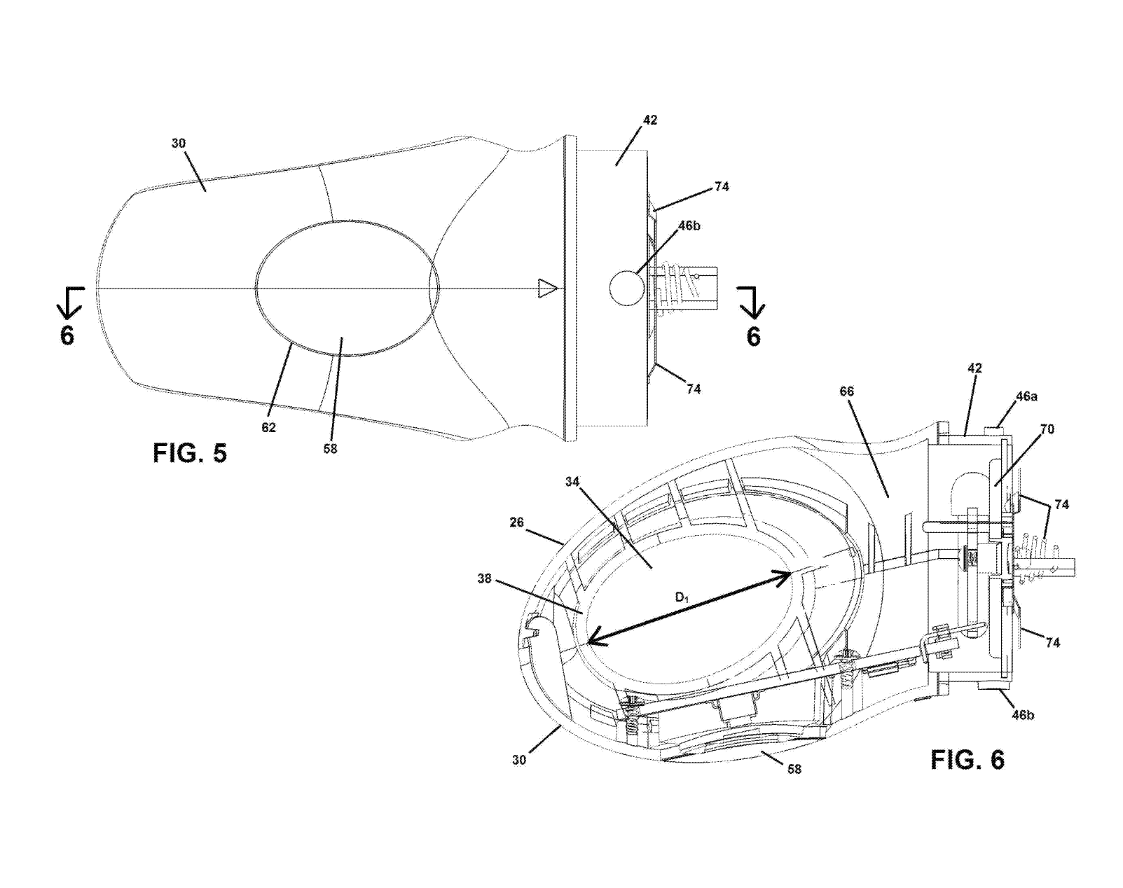

As shown in FIGS. 4-6, the handle 14 includes a user switch 58 that is received by (or positioned in) a hole 62 through the housing 22, and more specifically through the second housing portion 30 (shown in FIG. 5). The switch enables operation of the wand assembly 10 when actuated by the user. The switch 58 is preferably formed of a material that is different than the first material that forms the housing 22. For example, the switch 58 is formed of the second material (i.e. the same material as the insert 38) to improve tactile perception of the switch 58 by the user.

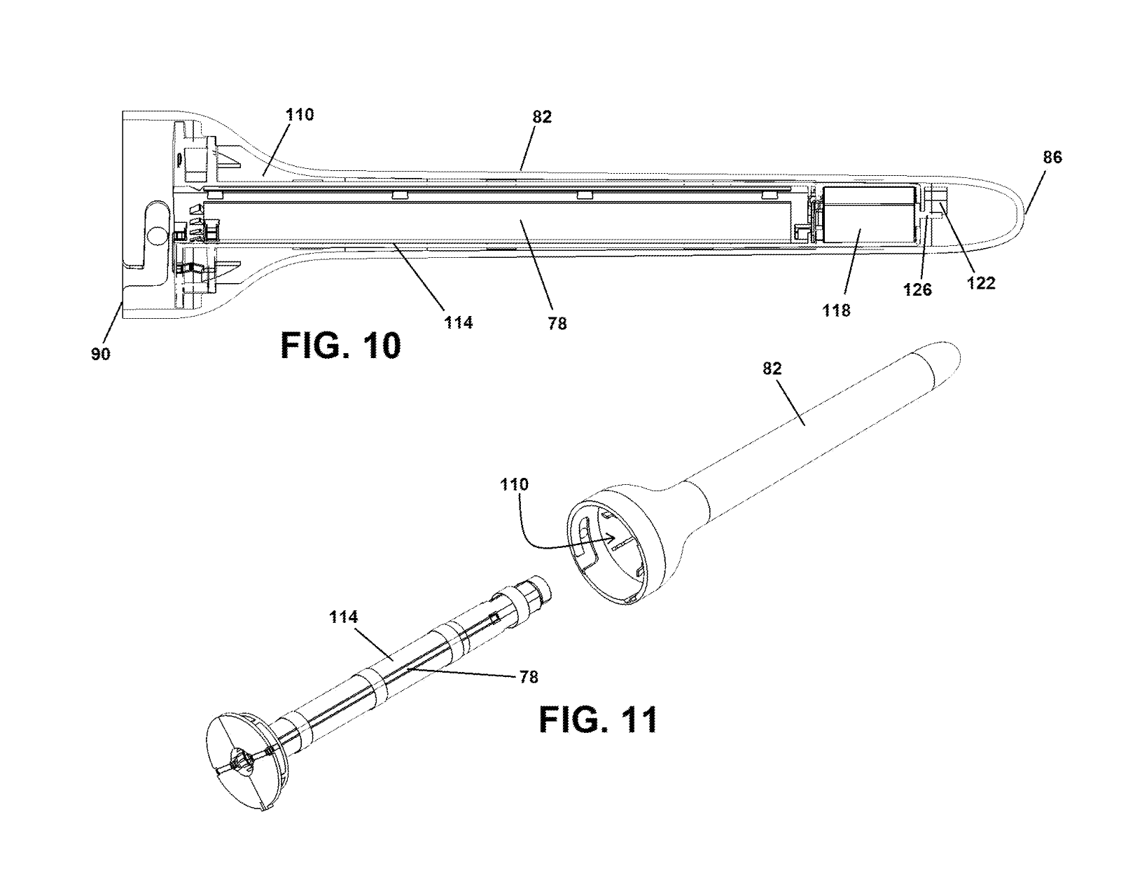

Referring now to FIG. 6, the housing 22 defines an interior portion 66 that defines an open area that houses a control or controller or controls 70 to operate the wand assembly 10. The controls 70 can includes a circuit or circuit board or printed circuit board (PCB). The controls 70 are in communication with the switch 58 such that when the switch 58 is actuated (or depressed) by a user, the controls 70 will influence operation of the wand assembly 10 (e.g., initiate operation or turn “on,” terminate operation or turn “off,” modify operation or change the rotational speed of a motor to increase or decrease vibration of the wand 18, etc.). The controls 70 are also in communication with a contact or electrical contact 74 (shown in FIGS. 3-6) positioned on the housing 22. When the wand 18 is coupled to the handle 14, the contact 74 is in electrical communication with a power source 78 (see FIG. 10) positioned in the wand 18. The electrical communication completes an electrical circuit between the power source 78, the controls 70, and the motor, allowing for operation of the wand assembly 10. In other examples of embodiments, the wand assembly 10 may not include a power source 78, controls 70, or motor, however may include the wand portion 18 that is in removable and replaceable engagement with the handle portion 14.

Referring now to FIGS. 7-11, an embodiment of the wand or wand portion 18 is illustrated. As shown in FIGS. 7-9, the wand 18 includes a sheath 82 having a tip or tip end 86 opposite a handle engaging end 90. In the illustrated embodiment, the handle engaging end 90 includes an opening 94 that provides access to an interior of the sheath 82.

The sheath 82 includes a size or dimension. The size can includes one or more of a length L and/or a diameter D (shown in FIG. 9). The length L generally extends from the tip end 86 to the handle engaging end 90. The diameter D is a diameter of the sheath 82 taken at a cross-section of a shaft or shaft portion 98.

The sheath 82 can also include the shaft 98 and a sloped portion 102. The sloped portion 102 generally extends from the handle engaging end 90 to the shaft 98. The shaft 98 generally extends from the sloped portion 102 to the tip 86. The slope of the sloped portion 102 depends on the difference between a diameter of the opening 94 and the diameter D of the shaft 98, with the greater the difference (e.g., a smaller diameter D of shaft 98 than the diameter of the opening 94, etc.) leading to a larger transition slope (i.e. slope of the sloped portion 102) between the handle engaging end 90 and the shaft 98.

The shaft 98 may include a tapered exterior 106 (shown in FIG. 9) that gradually extends along a portion, up to and including the entirety, of the shaft 98. The tapered exterior 106 generally has a decreasing cross-sectional diameter D along the shaft 98. For example, the diameter D decreases along the shaft 98 from an end proximate the handle engaging end 90 to the tip 86. In other examples of embodiments, the tapered exterior 106 can have an increasing cross-sectional diameter D along the shaft 98 (e.g., the diameter D increases along the shaft 98 from an end proximate the handle engaging end 90 to the tip 86).

Referring now to FIGS. 10-11, the sheath 82 may include a hollow interior 110 that is configured to receive an insert housing 114 (also shown in FIGS. 8-9). The insert housing 114 carries or houses the power source 78. The power source 78 may be any suitable source of electricity, including one or more batteries. For example, the power source 78 can include a plurality of batteries of any suitable or appropriate battery cell size (e.g., D, C, AA, AAA, etc.).

As shown in FIG. 10, the insert housing 114 also carries a vibration generation assembly (illustrated as a motor 118 that is connected to a weight 122 by a motor shaft 126). The weight 122 is preferable an offset (non-symmetric) mass or eccentric rotating mass. The motor 118 causes the weight 122 to rotate, with the offset mass of the weight 122 generating vibration that vibrates the sheath 82 of the wand 18. In other embodiments, the motor 118, weight 122, and motor shaft 126 can be separate from the insert housing 114. For example, the motor 118, weight 122, and/or motor shaft 126 can be positioned within the sheath 82 and in electrical communication with the controls 70 and the power source 78.

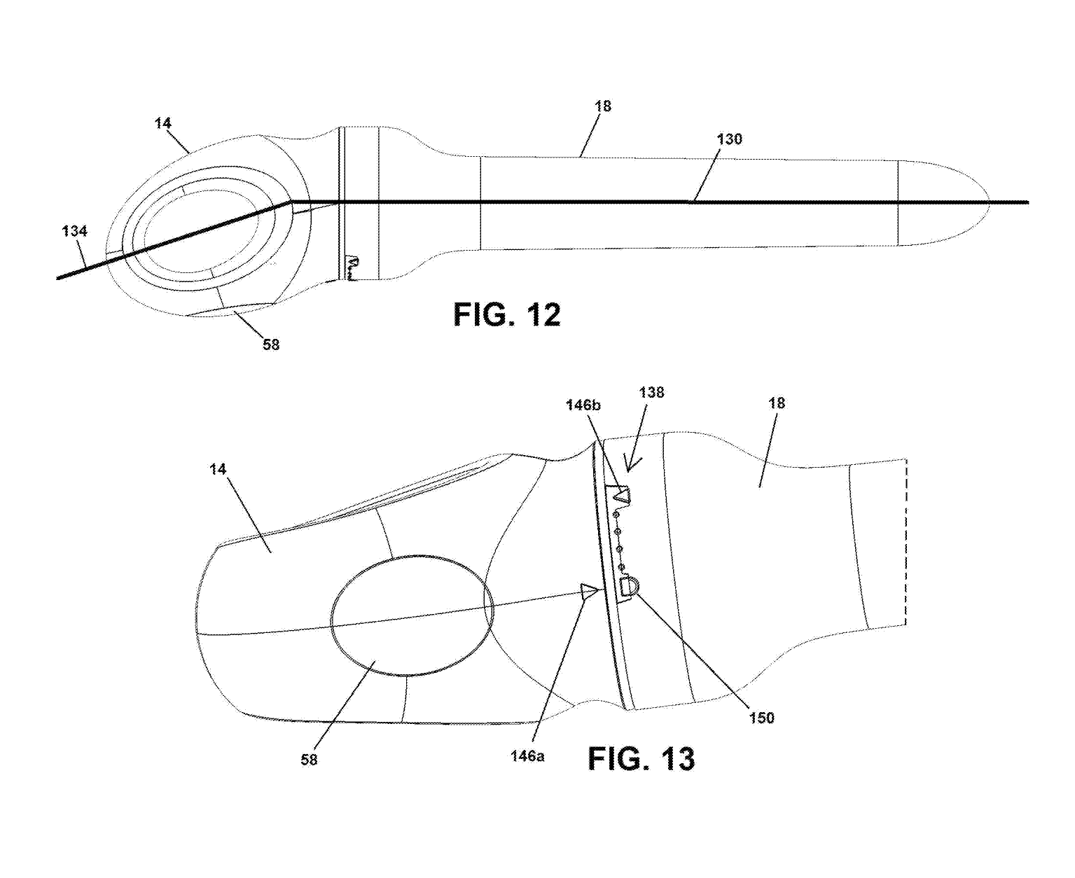

Referring now to FIG. 12, the wand 18 extends along a first axis or shaft axis 130. The shaft axis 130 can be positioned to approximately intersect a centroid of geometric center of the wand 18. A portion of the handle 14 is also positioned to extend along the shaft axis 130. The portion of the handle 14 can include the wand engaging portion (not shown in FIG. 12, as the wand engaging portion is received by the wand 18). The handle 14 or a portion thereof extends along a second axis of handle axis 134. The handle axis 134 can be positioned to approximately intersect a centroid of geometric center of the handle 14. The handle axis 134 is positioned at an oblique angle to the shaft axis 130. The switch 58 on the handle 14 is positioned on a side of the handle axis 134 where the angle between the wand axis 130 and the handle axis 134 is less than 180°. Stated another way, the portion of the handle 14 carrying the switch 58 is provided at an oblique angle to the wand 18, and further the angle is less than 180°. This angle provides a user comfortable access to the switch 58 during use of the wand assembly 10.

FIG. 13 illustrates aspects of a locking assembly 138. In the illustrated embodiment, the locking assembly 138 includes the projections 46a, 46b and the slots 50a, 50b (shown in FIGS. 6-8). Each projection 46a, 46b is received in a corresponding slot 50a, 50b. To guide the proper alignment of projection 46a, 46b to slot 50a, 50b, the wand assembly 10 can include indicia 142 to facilitate alignment and locking. For example, the indicia 142 can include a first alignment indicia 146a positioned on the handle 14, and a second alignment indicia 146b positioned on the wand 18. During engagement of the wand 18 to the handle 14, a user aligns the first and second alignment indicia 146a, 146b (illustrated as arrows that point to one another). When the first and second alignment indicia 146a, 146b are aligned, and the wand 18 and the handle 14 are engaged, the locking assembly is in proper alignment (e.g., the first slot 50a receives the first projection 46a, and the second slot 50b receives the second projection 46b). In the illustrated embodiment of the locking assembly 138, which is a bayonet type lock, the user can then adjust the wand 18 in relation to the handle 14 (e.g., rotate the handle 14 about the wand 18, rotate the wand 18 about the handle 14, etc.) until the indicia indicates the handle 14 and the wand 18 are locked together. For example, as illustrated in FIG. 13, the first alignment indicia 146a is aligned with a locking indicia 150 (shown as a padlock in a locked configuration). While the illustrated embodiment depicts the locking assembly 138 as a bayonet mount or bayonet lock, in other embodiments, the handle 14 and the wand 18 may lock together using any suitable type or style of lock that allows for locking and unlocking of the wand 18 to the handle 14.

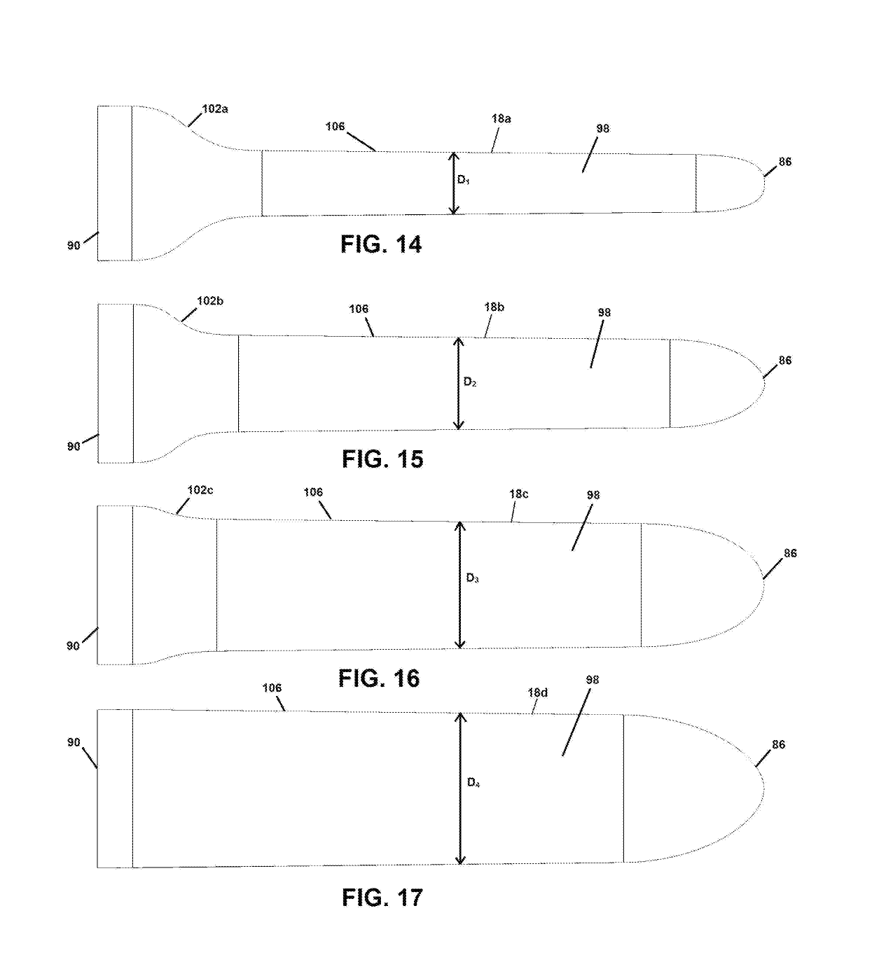

The wand assembly 10 as described herein is intended to have flexibility in use such that the handle 14 can be used with different wands 18 having different dimensions. Referring to FIGS. 14-17, a plurality of wands 18a, 18b, 18c, 18d are illustrated. The wands 18a-18d are substantially the same by including the elements discussed above in association with wand 18, except that the wands 18a-18d are different sizes or dimensions when compared to one another.

For example, in the illustrated embodiments, each wand 18a, 18b, 18c, 18d has a different cross-sectional diameter D of the shaft 98 when compared to one another. The first wand 18a has a first cross-sectional diameter D₁. The second wand 18b has a second cross-sectional diameter D₂ that is greater than the first cross-sectional diameter D₁. The third wand 18c has a third cross-sectional diameter D₃ that is greater than the first cross-sectional diameter D₁ and the second cross-sectional diameter D₂. The fourth wand 18d has a fourth cross-sectional diameter D₄ that is greater than the first cross-sectional diameter D₁, the second cross-sectional diameter D₂, and the third cross-sectional diameter D₃. It should be appreciated that each illustrated wand 18a, 18b, 18c, 18d has the tapered exterior 106. Accordingly, the comparative cross-sectional diameters D₁, D₂, D₃, D₄ are taken at approximately the same location along the length L of each wand 18a, 18b, 18c, 18d. Stated another way, the comparative cross-sectional diameters D₁, D₂, D₃, D₄ are taken at approximately the same distance from the tip end 86 or the handle engaging end 90.

Due to the different cross-sectional diameters D₁, D₂, D₃, D₄ of each shaft 98, the slope of the sloped portion 102 can differ between wands 18a, 18b, 18c, 18d. In the illustrated embodiments, the handle engaging end 90 has the same cross-sectional diameter for each of the wands 18a, 18b, 18c, 18d to allow for engagement of each wand 18a, 18b, 18c, 18d with the handle 14. Based on this standardized cross-section diameter of the handle engaging ends 90, the sloped portions 102 can differ between wands 18 to provide a suitable transition from the handle engaging end 90 to the shaft 98. For example, the first wand 18a has a first sloped portion 102a. The second wand 18b has a second sloped portion 102b that has less of a slope than the first sloped portion 102a. The third wand 18c has a third sloped portion 102c, which has less of a slope than both the first sloped portion 102a and the second sloped portion 102b. The fourth wand 18d does not have a sloped portion 102, as the fourth cross-sectional diameters D₄ of the shaft 98 is such that a transition sloped portion 102 between the handle engaging end 90 and the shaft 98 is not needed.

It should be appreciated that the illustrated wands 18a, 18b, 18c, 18d are examples of various sizes or dimensions. Other embodiments of the wand 18 may be any suitable or desired size or dimension. For example, the wands 18 may have suitable length L, any suitable diameter D, and or any suitable or desired shape.

The wand assembly 10 disclosed herein maybe be placed in commerce as separate units (e.g., the handle 14 and wands 18 are sold separately), or together as the wand assembly 10 (e.g. the handle 14 and a wand 18 are sold together). In addition, the wand assembly 10 may be placed in commerce (or commercially sold) as a wand kit or wand system that includes the handle 14 and a plurality of wands 18. For example, such a kit or system may include the wand assembly 10 and two or more of wands 18a, 18b, 18c, 18d, or the wand assembly 10 and all four of wands 18a, 18b, 18c, 18d. The kit or system provides customization for a user, as a user can select an appropriately sized wand 18 (such as one of wands 18a, 18b, 18c, 18d, among other sized wands) based on comfort during use, vaginal size, vaginal condition, physiology, or other factors.

The wand assembly 10 advantageously provides customization for a user by allowing a user to select a desired sized wand 18 for use with the handle 14. This multi-component arrangement allows for user adaptation of the wand assembly 10 as user needs change, as different sized wands 18 can be selectively used with the same handle 14. Accordingly, a user may continue to use the wand assembly 10 and associated wand system as needs change by changing wand 18 size, rather than having to purchase one or more new or different wands. The wand system (or kit) implementing the wand assembly 10 also provides user customization after purchase, as a user may not be aware of the appropriate wand 18 size the user needs. The user can then discretely and comfortably select the appropriately sized wand (such as wands 18a-18d) that is included with the wand system (or kit). These and other advantages may be realized from one or more embodiments of the wand assembly 10 disclosed herein or set forth in the claims.

What is claimed is:

1. A wand system comprising:
a plurality of wand portions, each wand portion having at least one dimension that differs from the other wand portions; and
a handle portion defining an aperture through the handle portion,
wherein each of the plurality of wand portions is configured to removably engage the handle portion to define a wand assembly.

2. The wand system of claim 1, further comprising a locking assembly that facilitates selective locking of each wand portion to the handle portion.

3. The wand system of claim 2, wherein the locking assembly is a bayonet type lock.

4. The wand system of claim 1, wherein the handle portion includes a housing, a portion of the housing defines an aperture provided entirely through the housing.

5. The wand system of claim 4, wherein the aperture is configured to receive one or more fingers of a user and the portion of the housing is configured to operate as a user handle.

6. The wand system of claim 1, wherein each of the plurality of wand portions includes a sheath defining a hollow interior, the hollow interior contains a vibration generation assembly and a power source.

7. The wand system of claim 6, wherein the handle portion includes a switch configured to selectively operate the wand assembly.

8. The wand system of claim 7, wherein the handle portion includes a controller in communication with the switch, and configured to be in electrical communication with the power source and the vibration generation assembly when one of the plurality of wands is engaged with the handle portion.

9. The wand system of claim 1, wherein the at least one dimension of each of the wand portions is a cross-sectional diameter of a shaft portion.
